(19) United States
(12) Patent Application Publication
(10) Pub. No.: US 2014/0224810 A1
(43) Pub. Date: Aug. 14, 2014

(54) Multi-Functional Flat Lid

(71) Applicant: Haim Bar-Akiva, East Windsor, NJ (US)

(72) Inventor: Haim Bar-Akiva, East Windsor, NJ (US)

(21) Appl. No.: 14/168,531

(22) Filed: Jan. 30, 2014

Related U.S. Application Data
(60) Provisional application No. 61/764,032, filed on Feb. 13, 2013.

(51) Int. Cl. A47J 27/00

(52) U.S. Cl. CPC A47J 27/002
USPC 220/573.1

(57) ABSTRACT

A lid is presented that is configured for placement onto the upstanding wall of a pot. The lid includes a pair of platforms that create a flat lid surface and a recessed handle that provides an ergonomic grasping area for easy placement and removal of the lid while maintaining a flat stacking surface. The first platform extends substantially horizontally from the perimeter of the lid ledge, whereas the second platform is horizontally disposed within a recessed concave area within the central portion of the platform. A handle extends upward from the center of the second platform to a height even with the first recession, thereby forming a flat lid upper surface that may support the base of a stacked pot thereon or utensils temporarily placed thereon while cooking.

### CROSS REFERENCE TO RELATED APPLICATION

This application claims the benefit of U.S. Provisional Application No. 61/764,032 filed on Feb. 13, 2013, entitled “Compact Utensil Pot Lid”. The above identified patent application is herein incorporated by reference in its entirety to provide continuity of disclosure.

### BACKGROUND OF THE INVENTION

1. Field of the Invention

The present invention relates lids that are adapted for placement on cooking pots. More specifically the invention relates to lids that include recessed platforms thereon, whereby the platforms enable pots to be placed on the surface of the lid during storage while providing a handle thereon for lifting the same.

Most forms of cookware require lids to prevent the contents within from escaping. These lids typically have a recessed perimeter that enable securement onto the pot and a handle configured for maneuvering the lid. The recessed perimeter acts as an “overcook edge” that prevents the contents from exiting by having the lid lie somewhat inside of the cooking pot instead of resting on top of the pot. The design is a simplistic one that keeps the heat and food within the cookware while still enabling easy removal of the lid.

While the traditional design of cookware lids are adequate for their own purposes, they do have their drawbacks. Traditional cookware lids typically lack platforms that facilitate the placement of cooking utensils, pots, pans, forks, knives, tongs, and spoons. Having a dedicated area on the lid of cookware is of importance to a user that has a limited amount of space in their cabinets. The present invention provides a flat area that enables the stacking of pots on top of the lid. Also, it is often desirable to keep cooking utensils separated when cooking a variety of dishes. The mixing of foods by the use of a common utensil has the potential to cross-contaminate the dishes, thereby spreading bacteria among the dishes. The use of a common utensil for all of the dishes can potentially change the intended flavors of the dish. The flat surface may also be utilized for holding the tongs or spoons that are used for each dish, thereby keeping the organized and separated.

Another drawback of traditional lids is that they typically include a handle that protrudes from the center of the lid. The positioning of the handle in the center of the lid provides an even weight distribution, thereby making it easy to grasp with one hand. However, while the location is convenient for grasping and maneuvering the lid, the positioning also prevents the lid from being stacked easily, which makes storage of multiple lids difficult.

There are common household solutions that attempt to remedy the drawbacks of the design of traditional lids. Solutions that overcome the cross-contamination of utensils involve placing the utensils adjacent to the pots and placing the utensils in separate locations. These solutions, however, are only successful if others are aware of which utensil is to be used in each pot. Solutions that overcome the drawbacks of the handle placement include that of having a dedicated shelf for the storage of lids, and storing the lid upside down within the pot. These solutions, however, are only practical if there are a limited number of pots and lids.

Several prior art devices are designed to remedy the drawbacks of a traditional lids. These devices often comprise a recess on the top of the lid that creates a flat upper surface; however, these devices fail to include a second recess that is configured to reduce the likelihood that pots would fall off the surface of the lid.

The present invention provides a lid configured for placement on top of a pot. The lid includes a first recessed platform around the perimeter of the lid, and a second recessed platform that surrounds the area of the handle. The first platform allows a user to securely place pots on top of the lid without having them fall off of the surface of the lid, while the second platform provides a flat surface that prevents interference from the handle when stacking pots on top of each other. These platforms of the lid create a space where utensils, pots and other items can be stacked, thereby reducing clutter and the amount of counter space needed for kitchen tools.

2. Description of the Prior Art

Devices have been disclosed in the prior art that relate to lids for cookware. These include devices that have been patented and published in patent application publications. These devices generally relate to recessed lids that create a flat upper surface. The following is a list of devices deemed most relevant to the present disclosure, which are herein described for the purposes of highlighting and differentiating the unique aspects of the present invention, and further highlighting the drawbacks existing in the prior art.

Devices of the prior art largely relate to lids that comprise recesses that provide a handle that reaches the height of the lid surface. These prior art lids are configured to provide convenient stacking of the lids. However, while these devices are appropriate for their own uses, they fail to anticipate the present invention by failing to provide recessed platforms that enable pots to be securely held thereon.

One such prior art device that fails to anticipate the present invention is U.S. Pat. No. 3,687,331 to Racz, discloses a cookware container comprising a cover that closes the open top of a pot. The cover is formed of an insulative material that is capable of reducing the heat loss though the wall of the pot. The cover further includes a recessed handle in order to provide a stable base. However, while the device of Racz teaches a recessed handle area, the device fails to further teach a second platform around the perimeter of the device that is configured to facilitate the placement of cooking pots and utensils.

Another prior art patent, U.S. Pat. No. 6,105,811 TO Alfred teaches an ergonomic cooking pan cover. The cover is designed for fitting on and covering the top of various sizes of pots, pans and skillets, in order to prevent the loss of steam and stopping the boiling-over of the contents within the container. The cooking lid includes a concave shape and includes a handle that extends upward from the center of the lid. The concave shape is formed of a series of concentric rings that enable the lid to fit over a variety of pot sizes. While the cooking cover of Alfred is appropriate for its own uses, the device fails to teach a lid configured for holding utensils, containers, or other items to be placed.

U.S. Pat. No. 6,298,773 to Cali discloses a cover configured for placement over a pot. The cover includes two recessed parts that are fitted together, whereby they are manually controllable or adjustable, in order to control the steam therein. The two parts comprise holes therein, whereby when the parts are rotated, they enable steam to be released from the lid. The lid, however, is configured to control the steam from a pot, and fails to anticipate the prior art.

Yet another prior art device, U.S. Pat. No. 8,123,067 to Thomson discloses a stacking pan set. The pans of the set are progressively smaller in diameter so that each pan fits within the previous pan and each lid fit within the next appropriately sized lid. However, while useful for its own purposes, the prior art device fails to teach a lid having two recessed platforms that enable items to be placed on the surface of the lid.

Finally, there are prior art designs for lids that have been patented. These generally relate to lids that have recessions. One such design Pat. D160,070 to Carr illustrates a pot having a lid thereon, whereby the lid includes an angled recession around the handle. Another prior art design, D412,810 to Alfred illustrates a concave shaped cooking lid, whereby the lid comprises a plurality of concentric recessions. While the designs of the prior art are similar in nature and relevant to the present invention, they fail to provide a pair of platforms that enable items to be placed on the surface of the lid, and for the handle to lie at an even height with the rest of the lid.

The present invention relates to a lid. The lid includes a first platform, which is located near the perimeter of the lid, and a second platform surrounding the handle. The perimeter of the lid includes a ledge, from which extends the first platform. The first platform forms a substantially flat upper lid surface that is capable of providing a placement area for pots during storage. The second platform extends from the first platform and forms a concave area that contains the handle of the lid. The handle extends upward from the second platform until a height even to the first platform area, thereby forming a flat upper surface platform with along the surface of the lid. This feature enables the placement of cooking utensils, pots, and other items on the surface of the lid, thereby reducing clutter and the likelihood of cross-contamination by the changing of utensils between dishes.

It is submitted that the present invention substantially diverges in design elements from the prior art and consequently it is clear that there is a need in the art for an improvement to existing pot and pan covering devices. In this regard the instant invention substantially fulfills these needs.

### SUMMARY OF THE INVENTION

In view of the foregoing disadvantages inherent in the known types of pot and pan lids now present in the prior art, the present invention provides a new device wherein the same can be utilized for providing convenience for the user when a pot covering lid is desired that comprises a flat surface that enables the placement of utensils.

It is therefore an object of the present invention to provide a new and improved pot and pan lid that has all of the advantages of the prior art and none of the disadvantages.

It is another object of the present invention to provide a lid that has a recessed handle, which creates a flat lid surface.

Another object of the present invention is to provide a recessed perimeter, thereby enabling items placed on the surface of the lid to remain in place.

Yet another object of the present invention is to provide a lid that is configured for holding a variety of pots and kitchen utensils thereon.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A displays a perspective view of the lid of the present invention.

FIG. 1B displays a cross-sectional view of the lid.

FIG. 2 displays a view of the lid disposed on the surface of a pot.

FIG. 3A displays a view of a pot disposed on the lid.

FIG. 3B displays a view of a spoon disposed on the lid.

FIG. 4 displays a view of the lid of the present invention in different sizes.

FIG. 5 displays a view of the lid of the present invention and a pot stacked thereon.

FIG. 6 displays a view of the lid of the present invention with an alternate ledge design.

### DETAILED DESCRIPTION OF THE INVENTION

Reference is made herein to the attached drawings. Like reference numerals are used throughout the drawings to depict like or similar elements of the pot and pan lid. For the purposes of presenting a brief and clear description of the present invention, the preferred embodiment will be discussed as used for providing closure of a pot or pan, while also providing a flat surface capable of supporting objects thereon. The figures are intended for representative purposes only and should not be considered to be limiting in any respect.

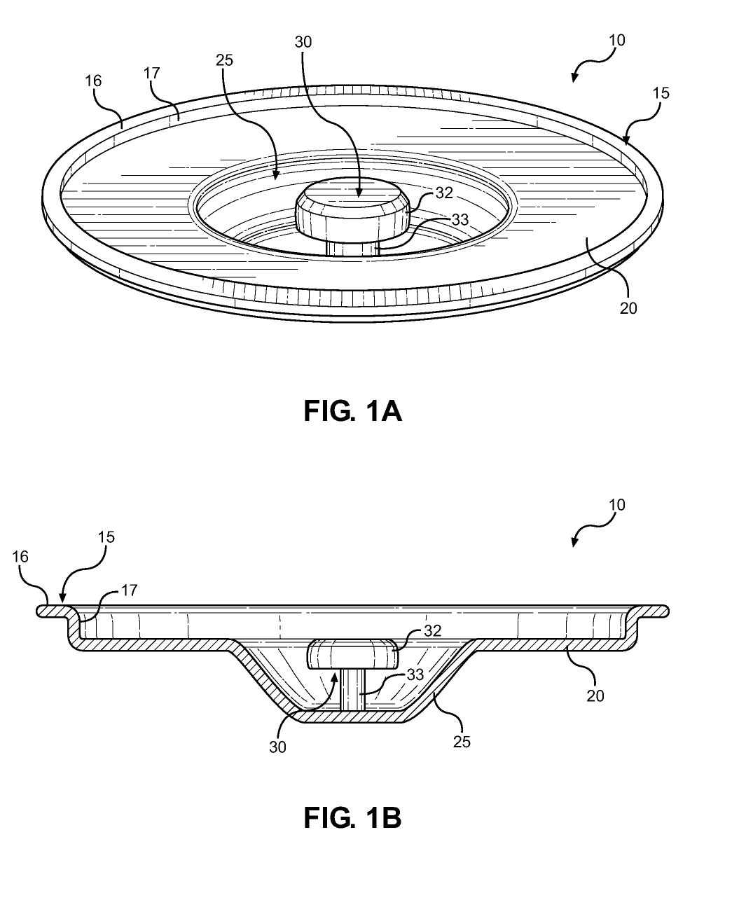

Referring now to FIGS. 1A and 1B, there are shown perspective and cross-sectional views of the lid, whereby FIG. 1A displays the perspective view and FIG. 1B displays the cross-sectional view of the lid, which is configured for covering pots. The lid 10 is constructed of metal, glass, plastic, wood, or other suitable materials that are capable of retaining heat, and includes an upper surface having a ledge 15, first 20 and second 25 recessed platforms, and a handle 30 for grasping and maneuvering the lid 10.

The ledge 15 is positioned around the perimeter of the lid 10 and extends a short distance inward from an outer edge of the upper surface of the lid, thereby forming a ledge-like extension. The ledge 15 is configured to rest on the upstanding walls of a pot to facilitate a closure that prevents or greatly reduces the loss of heat or steam during the cooking process. The ledge 15 comprises an L-shape having a first section 16 that is configured to rest on the upstanding wall of a pot, and a second section 17 extending downward therefrom. Extending horizontally from the ledge 15 is a first recessed platform 20 that forms a substantially flat upper lid surface at a height below that of the first section of the perimeter ledge 15.

Referring now to FIG. 1B, a second recessed platform 25 extends from the flat surface of the first platform 20 and curves downward therefrom, thereby forming a concave and sunken area on the lid 10. Positioned in the center of the second recessed platform 25 is a handle 30. The handle 30 extends upward from the center of the second platform 25, which facilitates the grasping of the handle 30 by providing an ergonomic and angled recess that enables access to the handle 30 and maneuverability of the lid 10. In order to further facilitate the grasping of the handle 30, the handle 30 may include a cylindrical stem 33 that leads into a knob 32. The knob 32 is configured to extend upward to a height even to the surface of the first recessed platform 20 of the lid 10. The knob 32 has a flat surface that forms an even surface with the first platform 20, thereby forming a flat surface within the perimeter ledge 15 of the lid 10 that enables the placement of objects thereon.

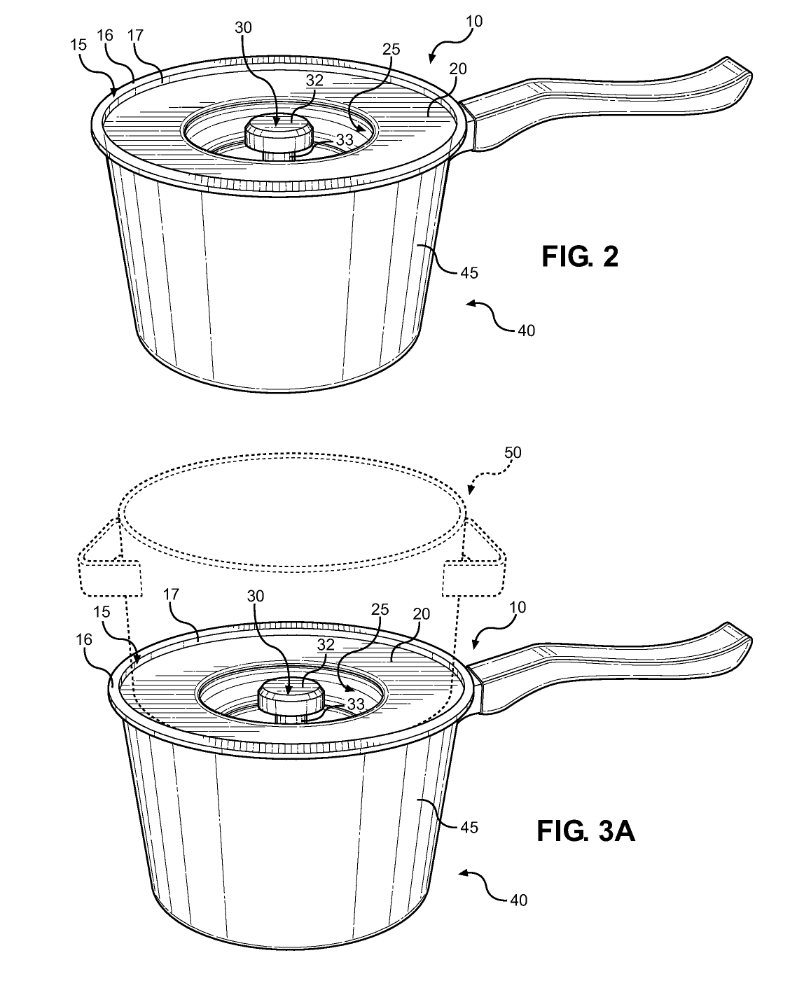

Referring now to FIG. 2, there is shown a view of the lid 10, while the first section 16 of the ledge 15 is disposed on the upstanding wall 45 of a pot 40. The lid 10 is sized and configured to fit on an appropriately sized pot, whereby the fitting provides a closure between the lid 10 and pot 40 that restricts the contents within the pot from escaping. The ledge 15 rests on the edge of the upstanding wall 45 of the pot 40 and comprises a downward section 17 that leads into a first platform 20 that aids in retaining the contents that reside within the pot 40.

The lid 10 provides a closure onto pots 40 similar to that of traditional lids, however the lid 10 further includes a pair of recessed platforms. The perimeter of the lid 10 comprises a ledge 15 that is configured to rest on the upstanding wall 45 of the pot 40. The ledge 15 comprises a first section 16 that is configured to rest on the walls 45 of a pot 40, and a second section 17 that extends downward from the first section of the ledge 15. A first platform 20 extends from the bottom of the second section 16 of the ledge 15 and forms a substantially flat platform thereon. A curved recession extends from the first platform 20, thereby forming a second platform 25. The second platform 25 forms a concave and sunken area on the lid 10, which lies further into the interior of the pot 40 than the first platform 20. A handle 30 extends upward from the center of the second platform 25 until the flat surface of the knob 32 is even with the first platform 20. The concave surface of the second platform 25 surrounds the handle 30 and forms an ergonomic design that aids in the grasping of the knob 32, thereby facilitating the easy removal of the lid 10 from a pot 40.

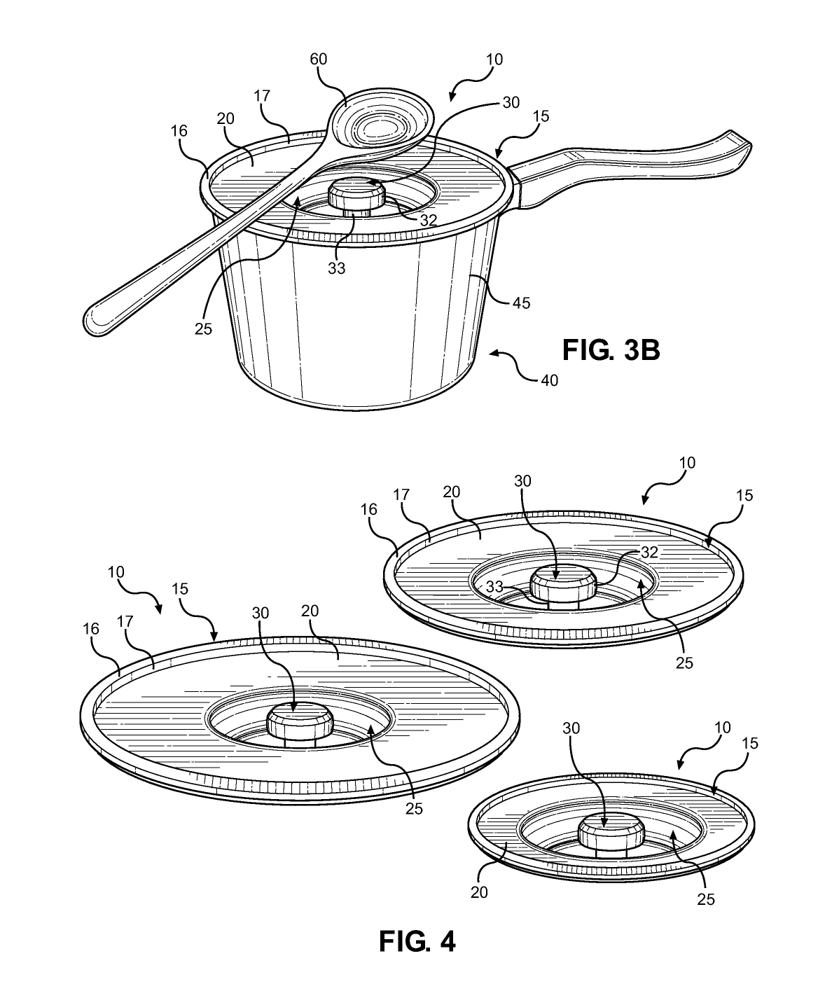

Referring now to FIG. 3A, there is shown an outline of a pot 50 resting on the lid 10 of the present invention. The lid includes a perimeter ledge 15 that rests on the upstanding wall 45 of a pot 40. The ledge 15 forms an L-shape wherein a first section 16 of the ledge 15 rests on the upstanding wall 45 of a pot 40 and a second section 17 that extends downward to form a perimeter barrier. The barrier formed by the perimeter ledge 15 enables items to be placed on the lid 10 during storage by providing a wall that prevents items thereon from sliding off of the lid 10. The flat surfaces formed by the first platform 20 and the handle 30, in combination with the barrier formed by the second section 17 of the ledge 15, form an upper lid surface that facilitates the placement and storage of pots 40 thereon.

Referring now to FIG. 3B, there is shown a view of the lid 10 with a utensil 60 placed on the surface of the lid 10. The placement of cooking utensils 60 on the surface of the lid 10 provides a sanitary location when using a plurality of utensils, thereby preventing cross-contamination and confusion when cooking a plurality of dishes. Similar to that of the pots 50 of FIG. 3A, a utensil 60 is retained on the upper surface by of the lid 15 by the barrier formed by the second section 17 of the ledge 15.

Referring now to FIG. 4, there are shown views of different sized lids 10, whereby the lids are configured to be fit onto a variety of correspondingly sized pots. It is contemplated that the lids may be offered in small, medium, large, and sizes therebetween. Additionally, the lids 10 may be offered in a variety of shapes that are configured to fit onto square or other polygonal shaped pots, pans, and other storage containers. The handle 30 of the lid is one that does not protrude above the first platform 20 and provides a means to grasp and lift the lid 10 while in use. The shape, style, and design of the handle 30 may be provided in many forms, falling within the scope of providing an upstanding member disposed along the second platform 25 for a user to grasp.

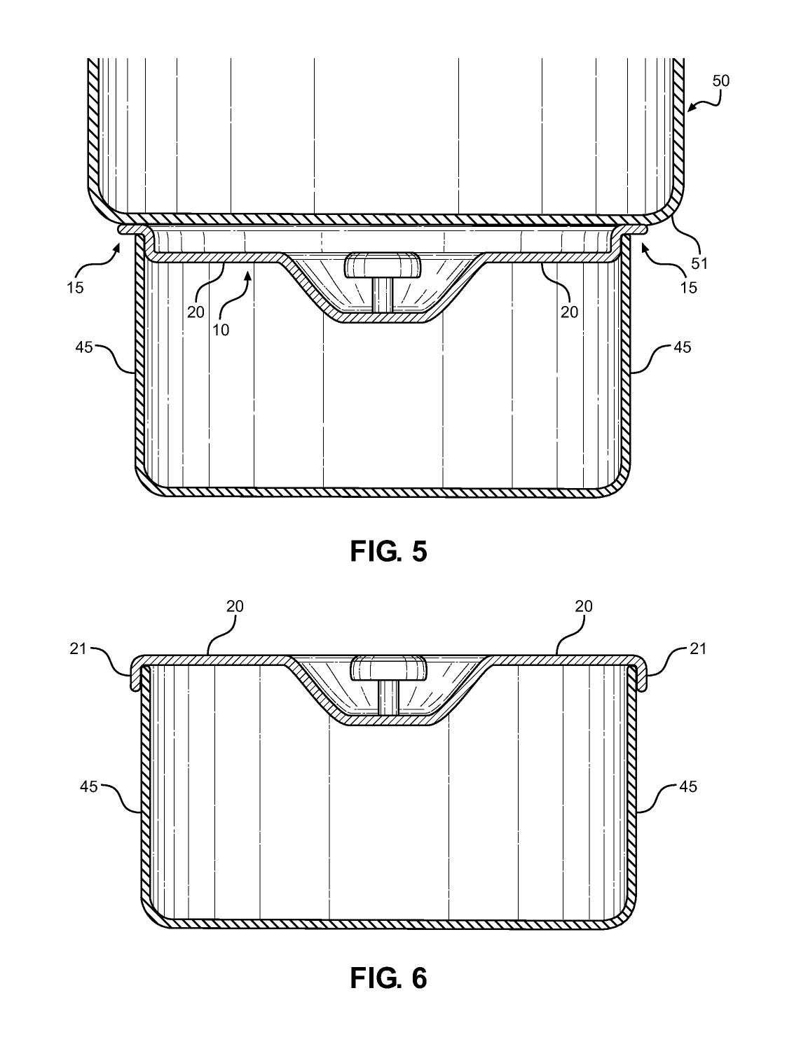

Referring to FIG. 5, there is shown a view of the lid of the present invention in a state supporting an additional pot 50 stacked on top thereof. The pot 50 above the lid 10 can be supported along the first platform 20 or along the ledge 15 thereof, wherein the outer extent 51 of the supported pot extends outward from the ledge 15 if the stacked pot 50 is larger than the lid 10. This configuration shows how the present invention can be used when stacking pots in contrast to that shown in FIG. 3A, wherein larger pots 50 can be stacked on the ledge and those of smaller size can be supported by the first platform 20 of the lid 10.

Referring finally to FIG. 6, there is shown an alternate configuration of the pot ledge 15, wherein the ledge comprises a downwardly vertical outer lip 21 that extends downward from the outer extent of the first platform 20. The outer lip 21 is adapted to secure around the upper portion of a pot when rested on top thereof, and does not recess the first platform 20 within the pot when secured thereto. Rather than an L-shaped section as shown in FIG. 1B, this embodiment includes a downward lip 21 and includes a flat upper surface defined by the first platform 20. The lip 21 engages the upstanding wall 45 of the pot and forms a more secure seal along the upper portion of the pot when the lid is deployed.

The present invention provides a new and improved lid 10 that is configured for placement onto the upstanding wall of a pot. The lid 10 includes a ledge 15, a first platform, and a second platform. The ledge 15 is positioned around the perimeter of the lid 10 and is configured for placement on the upstanding wall 45 of a pot 40, thereby facilitating a closure that retains the contents of the dish within the pot 40. The first platform 20 extends from the ledge 15 and forms a flat surface that extends towards the center of the lid 10. The second platform 25 extends downward from the first platform 20 and forms a sunken concave area around the handle 30, whereafter the handle 30 extends upward until a height that is even with the first platform 20. The flat surface of the knob 32 and the first platform 20 form a flat upper surface that enables the placement of pots and utensils thereon, while the ledge 15 provides a barrier that retains pots placed on the lid 10. The flat upper portion of the ledge furthermore serves as a location for placement of pots thereon when stacked.

The present invention is designed for those who desire a lid having a flat upper surface, onto which pots may be placed during storage, thus providing additional storage options for the user. The lid provides an ergonomic grasping area, a platform that forms a flat surface, and a perimeter ledge that forms a barrier that prevents pots placed thereon from falling off the lid.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A lid configured for placement on a pot, comprising:
a lid surface comprising a first and second platform and a perimeter ledge;
said perimeter ledge configured for placement on an upstanding wall of a pot;
said first platform extending substantially horizontally from said ledge;
a substantially central concave area along said first platform;
said second platform disposed substantially horizontally and below said first platform and recessed within said concave area;
a handle that extends from said second platform.

2. The lid of claim 1, wherein said ledge forms a barrier that retains objects that are placed on the surface of said lid.

3. The lid of claim 1, wherein said handle includes a stem and a knob, whereby said knob has a flat upper surface that aligns with said first platform.

4. The lid of claim 1, wherein
said perimeter ledge further comprises a first section configured for placement on an upstanding wall of a pot and a second section extending downward from said first section for form a substantially L-shaped ledge;
said first platform extending substantially horizontally from said downward section of said ledge.

5. The lid of claim 1, wherein
said perimeter ledge further comprises a downwardly vertical outer lip;
said first platform extending substantially horizontally from said outer lip.
